(19) United States
(12) Patent Application Publication
(10) Pub. No.: US 2026/0312756 A1
(43) Pub. Date: Oct. 8, 2026

(54) REDUCED BANDWIDTH PULSE SHAPING SCHEMES FOR SPECTRAL EFFICIENCY

(71) Applicant: QUALCOMM Incorporated, San Diego, CA (US)

(72) Inventors: Vinayak SURESH, San Diego, CA (US); Jing JIANG, San Diego, CA (US); Juergen CEZANNE, Ocean Township, NJ (US); Peter GAAL, San Diego, CA (US)

(21) Appl. No.: 19/633,683

(22) Filed: Mar. 30, 2026

Related U.S. Application Data
(60) Provisional application No. 63/783,038, filed on Apr. 3, 2025.

(51) Int. Cl. H04L 5/00; H04L 25/03

(52) U.S. Cl. CPC H04L 5/0048; H04L 5/0007; H04L 25/03834

(57) ABSTRACT

This disclosure provides methods, components, devices and systems for bandwidth pulse shaping. For example, a user equipment (UE) may pulse shape a set of modulated symbols to obtain a symbol subset for discrete Fourier transform spread orthogonal frequency division multiplexing (DFT-s-OFDM) waveform transmission. The set of modulated symbols may have a symmetry in the frequency domain, where each symbol has a corresponding conjugate copy of the symbol or is purely real. The UE may pulse shape, in accordance with a bandwidth reduction ratio, up to each conjugate copy in the set of symbols without losing information. The UE may transmit the DFT-s-OFDM waveform using the symbol subset. In some examples, the UE may pulse shape the set of symbols such that the bandwidth of the DFT-s-OFDM waveform conforms with a bandwidth indicated in a resource allocation.

### CROSS REFERENCE

This Patent Application claims the benefit of U.S. Provisional Patent Application No. 63/783,038 by SURESH et al., entitled “REDUCED BANDWIDTH PULSE SHAPING SCHEMES FOR SPECTRAL EFFICIENCY,” filed Apr. 3, 2025, assigned to the assignee hereof, and expressly incorporated herein.

### TECHNICAL FIELD

This disclosure relates generally to wireless communication, and more specifically to systems, devices, methods, and techniques associated with reduced bandwidth pulse shaping schemes for spectral efficiency.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

Some wireless communications systems may communicate using discrete Fourier transform spread orthogonal frequency division multiplexing (DFT-s-OFDM) transmissions.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include wirelessly receiving first control information indicating a configuration for discrete Fourier transform spread orthogonal frequency division multiplexing (DFT-s-OFDM) waveform transmission, the configuration indicating a modulation scheme and a pulse shaping scheme, wirelessly receiving second control information indicating a resource allocation for transmission of a DFT-s-OFDM waveform, where a first bandwidth of the resource allocation is different from a second bandwidth associated with a set of multiple symbols output by the modulation scheme, and wirelessly transmitting the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth.

A UE for wireless communications is described. The UE may include a processing system that includes processor circuitry and memory circuitry that stores code. The processing system may be configured to cause the UE to wirelessly receive first control information indicating a configuration for DFT-s-OFDM waveform transmission, the configuration indicating a modulation scheme and a pulse shaping scheme, wirelessly receive second control information indicating a resource allocation for transmission of a DFT-s-OFDM waveform, where a first bandwidth of the resource allocation is different from a second bandwidth associated with a set of multiple symbols output by the modulation scheme, and wirelessly transmit the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth.

Another UE for wireless communications is described. The UE may include means for wirelessly receiving first control information indicating a configuration for DFT-s-OFDM waveform transmission, the configuration indicating a modulation scheme and a pulse shaping scheme, means for wirelessly receiving second control information indicating a resource allocation for transmission of a DFT-s-OFDM waveform, where a first bandwidth of the resource allocation is different from a second bandwidth associated with a set of multiple symbols output by the modulation scheme, and means for wirelessly transmitting the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth.

A non-transitory computer-readable medium storing code for wireless communications is described. The code may include instructions executable by one or more processors to wirelessly receive first control information indicating a configuration for DFT-s-OFDM waveform transmission, the configuration indicating a modulation scheme and a pulse shaping scheme, wirelessly receive second control information indicating a resource allocation for transmission of a DFT-s-OFDM waveform, where a first bandwidth of the resource allocation is different from a second bandwidth associated with a set of multiple symbols output by the modulation scheme, and wirelessly transmit the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth.

Some examples of the method, UEs, and non-transitory computer-readable medium described herein may further include operations, features, means, or instructions for wirelessly transmitting an indication of a bandwidth reduction ratio associated with the pulse shaping scheme, the bandwidth reduction ratio corresponding to a quantity of symbols removed from the set of multiple symbols to obtain the symbol subset. In some examples of the method, UEs, and non-transitory computer-readable medium described herein, wirelessly transmitting the DFT-s-OFDM waveform may include operations, features, means, or instructions for wirelessly transmitting the DFT-s-OFDM waveform including an indication of a bandwidth reduction ratio applied by the pulse shaping scheme.

Some examples of the method, UEs, and non-transitory computer-readable medium described herein may further include operations, features, means, or instructions for wirelessly receiving control signaling indicating a bandwidth reduction ratio associated with the pulse shaping scheme, where a quantity of symbols removed from the set of multiple symbols by the pulse shaping scheme to obtain the symbol subset may be based on the bandwidth reduction ratio.

### BRIEF DESCRIPTION OF THE DRAWINGS

FIG. 1 shows an example of a wireless communication system.

FIG. 2 shows an example of a signaling configuration that supports reduced bandwidth pulse shaping schemes for spectral efficiency.

FIG. 3 shows an example of a transmission chain that supports reduced bandwidth pulse shaping schemes for spectral efficiency.

FIG. 4 shows an example of a process flow that supports reduced bandwidth pulse shaping schemes for spectral efficiency.

FIG. 5 shows a block diagram of a processing system that supports reduced bandwidth pulse shaping schemes for spectral efficiency.

FIG. 6 shows a diagram of a system including a device that supports reduced bandwidth pulse shaping schemes for spectral efficiency.

FIGS. 7 through 9 show flowcharts illustrating methods that support reduced bandwidth pulse shaping schemes for spectral efficiency.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-s-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may communicate with a network entity in accordance with a modulation scheme. For example, the UE may modulate different quantities of bits into respective symbols for transmission in accordance with the modulation scheme. The UE may transmit a discrete Fourier transform spread orthogonal frequency division multiplexing (DFT-s-OFDM) transmission based on performing a discrete Fourier transform (DFT) on a set of modulated symbols. In an example, the UE may generate and transmit a DFT-s-OFDM transmission in accordance with a

$$\frac{π}{2}$$

binary phase-shift keying (BPSK) modulation scheme. However, due to a frequency domain symmetry associated with the

$$\frac{π}{2} BPSK$$

modulation scheme, the DFT-s-OFDM transmission may include the same information over multiple resources (e.g., the DFT-s-OFDM transmission may include redundant information), which may decrease a spectral efficiency of the DFT-s-OFDM transmission. In some examples, it may be desirable to increase the spectral efficiency of the DFT-s-OFDM transmission (e.g., based on the frequency domain symmetry of the

$$\frac{π}{2} BPSK$$

modulation scheme, based on inefficiencies of other modulation schemes). Spectral efficiency may refer to how efficiently (e.g., in bits per resource element (RE)) the UE uses an allocated bandwidth to transmit data.

Aspects of the subject matter described in this disclosure relate to a UE pulse shaping the set of modulated symbols output by the DFT to obtain a subset of symbols for DFT-s-OFDM transmission. For example, the set of modulated symbols may have a symmetry in the frequency domain where each symbol has a corresponding conjugate copy of the symbol or is purely real (e.g., has no imaginary part and thus no conjugate copy). The UE may receive control information indicating a modulation scheme and a pulse shaping scheme for obtaining a subset of symbols from the set of symbols in accordance with the frequency-domain symmetry. For example, the UE may pulse shape up to each conjugate copy in the set of symbols without losing information. The UE may also receive an indication of a resource allocation for transmission of the DFT-s-OFDM waveform, and the UE may transmit the DFT-s-OFDM waveform using the subset of symbols pulse shaped in accordance with the pulse shaping scheme and a frequency-domain symmetry. As such, the DFT-s-OFDM waveform may, in some examples, be generated using only the subset of symbols. Any symbols outside of the subset may be omitted and thus not used to generate the DFT-s-OFDM waveform.

The UE may pulse shape the set of symbols such that the bandwidth of the DFT-s-OFDM waveform conforms with the bandwidth indicated in the resource allocation. For example, the UE may generate a modulation sequence with a larger bandwidth than the allocated bandwidth and pulse shape the modulation sequence such that the bandwidth associated with the subset of symbols is substantially within the allocated bandwidth. In some examples, the UE may perform the pulse shaping in accordance with a bandwidth reduction ratio. The UE may select the bandwidth reduction ratio based on one or more criteria. Additionally, or alternatively, the UE may receive an indication of the bandwidth reduction ratio.

Particular aspects of the subject matter described in this disclosure can be implemented to realize one or more of the following potential advantages. In some examples, by transmitting the DFT-s-OFDM waveform where the set of symbols are pulse shaped in accordance with the pulse shaping scheme and the frequency-domain symmetry to obtain the symbol subset, the described techniques can be used to increase the spectral efficiency of the DFT-s-OFDM waveform transmission relative to DFT-s-OFDM waveforms where the set of symbols are not pulse shaped. For example, if the DFT-s-OFDM waveform is generated in accordance with a

$$\frac{π}{2} BPSK$$

modulation scheme, the DFT-s-OFDM waveform may include the same information over multiple symbols based on a frequency domain symmetry of the

$$\frac{π}{2} BPSK$$

modulation scheme, thereby decreasing the spectral efficiency of the DFT-s-OFDM waveform. Based on pulse shaping the set of symbols in accordance with the frequency-domain symmetry to obtain the symbol subset, the DFT-s-OFDM waveform may use fewer resources to transmit the same information, thereby increasing the spectral efficiency of the DFT-s-OFDM waveform. That is, the set of symbols may be pulse shaped into a narrower bandwidth without losing information. Moreover, the pulse shaping techniques discussed herein may be used to manage peak-to-average power ratio (PAPR) growth when puncturing symbols. In an example, as a quantity of pulse shaped symbols increases, the PAPR of the DFT-s-OFDM waveform may increase and the UE may transmit the DFT-s-OFDM waveform using less power (e.g., more backoff). However, pulse shaping the set of symbols in accordance with the pulse shaping scheme and the frequency domain symmetry may result in a decrease in the PAPR, which may enable the UE to transmit the DFT-s-OFDM using more power.

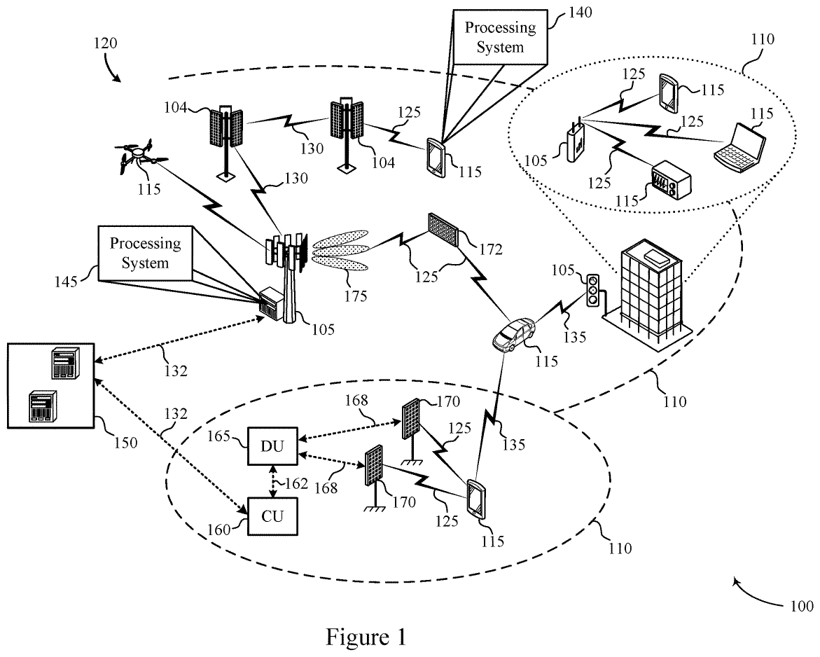

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-s-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for reduced bandwidth pulse shaping schemes for spectral efficiency. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support increased spectral efficiency by transmitting a DFT-s-OFDM waveform associated with a symbol subset obtained by pulse shaping a set of symbols in accordance with a pulse shaping scheme and a frequency-domain symmetry of the set of symbols.

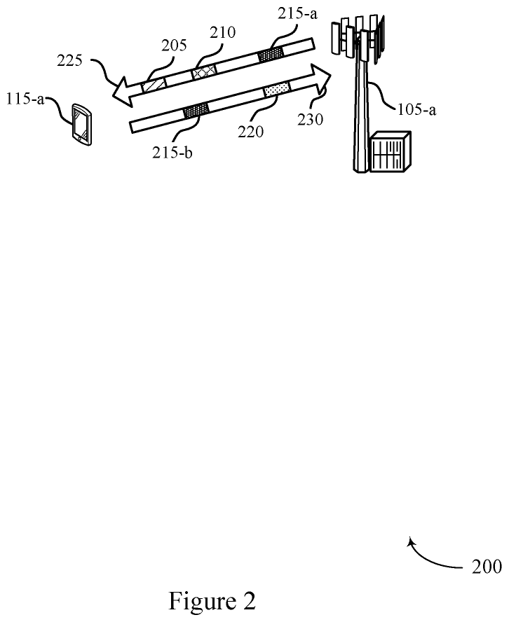

FIG. 2 shows an example of a signaling configuration 200 that supports reduced bandwidth pulse shaping schemes for spectral efficiency. For example, the signaling configuration 200 may include a UE 115-a and a network entity 105-a, which may be examples of the corresponding devices described herein, including with reference to FIG. 1. The UE 115-a may receive downlink communications via a downlink channel 225 between the UE 115-a and the network entity 105-a, and the UE 115-a may transmit uplink communications via an uplink channel 230 between the UE 115-a and the network entity 105-a.

In some wireless communications systems, it may be desirable to increase a spectral efficiency in which the UE 115-a communicates with the network entity 105-a (or vice versa). Spectral efficiency may refer to how efficiently a communication system uses its allocated bandwidth to transmit data. In some examples, spectral efficiency may be a measurement of a quantity of bits per RE. For example, the UE 115-a may encode different quantities of bits (e.g., information bits, bits to transmit to the network entity 105-a) in respective symbols of an uplink communication in accordance with a respective modulation scheme (e.g., BPSK modulation schemes may encode one bit per symbol, QPSK modulation schemes may encode two bits per symbol). In some examples, the UE 115-a may perform a DFT operation on a time-domain sequence of the modulated symbols to spread the symbols across one or more subcarriers, perform an inverse fast Fourier transform (IFFT) operation on the output of the DFT operation, and transmit a DFT-s-OFDM waveform 220 that includes the sequence of symbols based on performing the IFFT operation.

In some examples, the UE 115-a may transmit the DFT-s-OFDM waveform 220 in the uplink channel 230 in accordance with a

$$\frac{π}{2} BPSK$$

modulation scheme. For example, the UE 115-a may transmit the DFT-s-OFDM waveform 220 based on the

$$\frac{π}{2} BPSK$$

modulation scheme being associated with a relatively low peak-to-average power ratio (PAPR) relative to other modulation schemes, such as QPSK. To communicate in accordance with the

$$\frac{π}{2} BPSK$$

modulation scheme, the UE 115-a may select alternate constellation points (or symbols) from two orthogonal BPSK constellation sets. For example, a first BPSK constellation set may be {+1, −1} and a second BPSK constellation set may be {+1j,−1j}. The UE 115-a may alternately select constellation points from the first and second constellation sets to obtain a sequence of modulated symbols. An example sequence may be {1,1j,−1, 1j,1,−1j,1,−1j,−1, 1j}.

Although first and second constellation sets {+1, −1} and {+1j,−1j} are discussed, it is to be understood that any two or more orthogonal constellation sets may be used in accordance with the techniques described herein. For example, the first constellation set may be

$$\{ + \frac{1}{√ 2} + \frac{1}{√ 2} j , - \frac{1}{\sqrt{2}} - \frac{1}{√ 2} j \}$$

and the second constellation set may be

$$\{ + \frac{1}{√ 2} - \frac{1}{\sqrt{2}} j , - \frac{1}{\sqrt{2}} + \frac{1}{√ 2} j \} .$$

Further, while the techniques herein are described with reference to rank 1 transmission (e.g., transmission of a single data stream) for discussion purposes, it is to be understood that the disclosure supports higher rank transmission (e.g., rank 2, rank 3, rank 4, and so on).

In some examples, the UE 115-a may perform a DFT operation on the modulated symbols of the sequence associated with the

$$\frac{π}{2} BPSK$$

modulation scheme. An output of the DFT operation may result in a sequence of symbols with a frequency-domain symmetry described further with reference to FIG. 2. The symmetry may be based on selecting the alternating real and imaginary symbols in the modulation sequence. Based on the frequency-domain symmetry, the sequence of symbols may include conjugate copies of symbols. For example, a symbol at an index k of the sequence may have a conjugate copy at index

$$\frac{L}{2} - k$$

of the sequence, where L is the quantity of symbols in the sequence. As discussed herein, a conjugate copy may refer to a symbol (e.g., represented as a complex number) that has the same absolute real and imaginary values, where the sign of the imaginary part of the symbol is the opposite of the sign of its corresponding copy (e.g., for a symbol a+bj, its conjugate copy may be a−bj).

In accordance with the techniques described herein, the UE 115-a may pulse shape the sequence of symbols to obtain a subset of symbols for DFT-s-OFDM transmission. For example, each of the conjugated copies may be pulse shaped (e.g., punctured) without information loss, which may increase spectral efficiency based on transmitting the same amount of information using fewer resources (e.g., fewer symbols or REs). In some examples, the UE 115-a may receive control information 205 from the network entity 105-a that indicates a modulation scheme and a pulse shaping scheme for DFT-s-OFDM transmission. The UE 115-a may also receive control information 210 indicating a resource allocation for transmission of a DFT-s-OFDM waveform. In response to receiving the control information 205 and the control information 210, the UE 115-a may transmit the DFT-s-OFDM waveform 220 using a subset of symbols pulse shaped in accordance with the pulse shaping scheme and the frequency-domain symmetry.

The UE 115-a may pulse shape the sequence of symbols such that the bandwidth of the DFT-s-OFDM waveform 220 conforms with the bandwidth indicated in the control information 210. That is, the UE 115-a may generate a modulation sequence associated with a bandwidth larger than the allocated bandwidth and pulse shape the modulation sequence such that the bandwidth associated with the subset of symbols satisfies the allocated bandwidth. In some examples, the UE 115-a may receive an indication 215-a of a bandwidth reduction ratio. The bandwidth reduction ratio may correspond to a quantity of symbols removed from the modulation sequence to obtain the subset of symbols.

Additionally, or alternatively, the UE 115-a may transmit an indication 215-b of the bandwidth reduction ratio used to transmit the DFT-s-OFDM waveform 220. In some cases, the DFT-s-OFDM waveform 220 may include the indication 215-b (e.g., the bandwidth reduction ratio may be part of the PUSCH). The size of the DFT may be based on the bandwidth reduction ratio. For example, if the bandwidth reduction ratio is 40%, the UE 115-a may increase the size (e.g., in points) of the DFT by 40% relative to the allocated resources indicated in the control information 210, and the UE 115-a may obtain a subset of symbols based on pulse shaping (e.g., puncturing) 40% of the sequence output by the DFT. Based on the frequency-domain symmetry of the sequence, the UE 115-a may pulse shape up to

$$\frac{L}{2} - 1$$

symbols (or nearly 50%) without losing information. In some examples, the UE 115-a may pulse shape more than

$$\frac{L}{2} - 1$$

symbols based on satisfying one or more receive performance criteria, error vector magnitude criteria, or a combination thereof. In some examples, by pulse shaping the set of modulated symbols and transmitting the DFT-s-OFDM waveform using the subset of symbols, the described techniques can be used to increase the spectral efficiency of DFT-s-OFDM waveform communication.

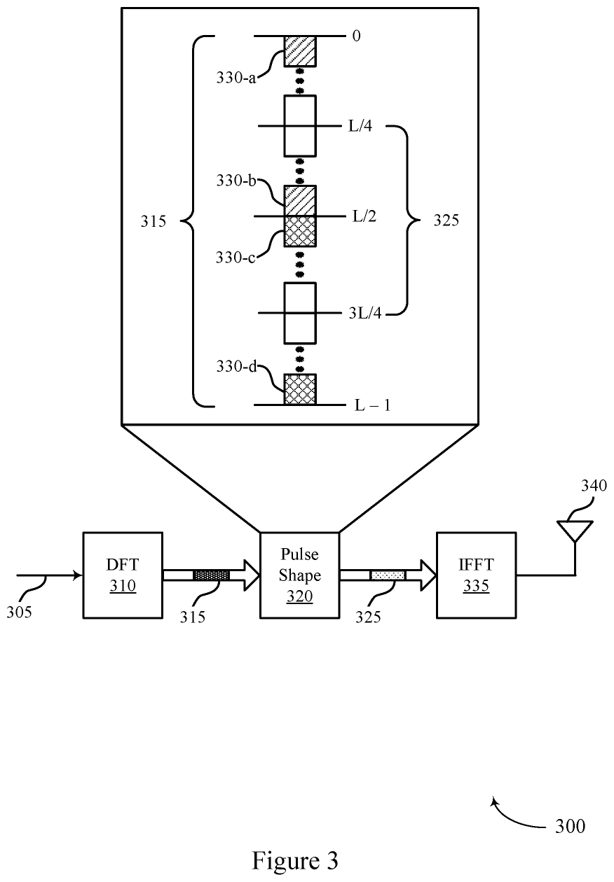

FIG. 3 shows an example of a transmission chain 300 that supports reduced bandwidth pulse shaping schemes for spectral efficiency. The transmission chain 300 may implement or be implemented by aspects of the wireless communication system 100 or the signaling configuration 200. For example, a UE 115 (e.g., the UE 115-a) may transmit a DFT-s-OFDM waveform in accordance with a modulation scheme and a pulse shaping scheme.

In the transmission chain 300, the UE 115 may perform a DFT operation 310 on a set of symbols 305. The set of symbols 305 may be based on the modulation scheme. For example, the UE 115 may modulate a set of bits into the set of symbols 305 in accordance with the modulation scheme (e.g., a

$$\frac{π}{2} BPSK$$

modulation scheme, an offset QPSK modulation scheme, an offset QAM scheme, an offset QAM scheme with an offset different from a 0.5 symbol offset). The set of symbols 305, sₖ, may include a quantity of L symbols. The DFT operation 310 may output a set of symbols 315 (e.g., a frequency-domain representation of the set of symbols 305). For example, the set of symbols 315, Sₖ, may include the quantity of L symbols (e.g., where an index of a respective symbol, k=0, 1, 2, . . . , L−1).

In some examples, the set of symbols 315 may have a frequency-domain symmetry. That is, the set of symbols 315 may satisfy Equation 1:

$${S}_{k} = {S}_{\frac{L}{2} - k}^{*} \qquad ( 1 )$$

where Sₖ is a symbol at the index k in the set of symbols 315, L is the quantity of symbols in the set of symbols 315, and

$${S}_{\frac{L}{2} - k}^{*}$$

is the conjugate copy of Sₖ. That is, the real portion of

$${S}_{\frac{L}{2} - k}^{*}$$

may be the same as the real portion of Sₖ and the imaginary portion of

$${S}_{\frac{L}{2} - k}^{*}$$

may be the imaginary portion of Sₖ multiplied by −j. For any set of symbols 315 with a quantity of L symbols, the symbols at

$${S}_{\frac{L}{4}} and {S}_{\frac{3 L}{4}}$$

may be purely real (e.g., include no imaginary part), and each symbol Sᵢ between indices

$$\frac{L}{4} + 1 and \frac{3 L}{4} + 1$$

may have a conjugate copy outside the indices

$$[ \frac{L}{4} , \frac{3 L}{4} ] .$$

For example, for L=8,

$${S}_{0} = {S}_{4}^{*} , {S}_{1} = {S}_{3}^{*} , {S}_{2} = {S}_{2}^{*}$$

(e.g., and is purely real),

$${S}_{5} = {S}_{- 1}^{*} = {S}_{7}^{*} , and {S}_{6} = {S}_{- 2}^{*} = {S}_{6}^{*}$$

(e.g., and is purely real). In another example, the symbol 330-a may be the conjugate copy of the symbol 330-b, and the symbol 330-c may be the conjugate copy of the symbol 330-d.

In some examples, Equation 1 may be derived based on writing the set of symbols 305 as

$${s}_{k} = {t}_{k} {e}^{j \frac{k π}{2}} ,$$

where the sequence tₖ is purely real (e.g., contains 1's and −1's). The DFT of Tₖ of a purely real sequence may satisfy the symmetry

$${T}_{k} = {T}_{L - k}^{*} .$$

### Since

$${s}_{k} = {t}_{k} {e}^{j \frac{k π}{2}} = {t}_{k} {e}^{j \frac{2 k π}{L} ( \frac{L}{4} )} , {S}_{k} = {T}_{k - ( \frac{L}{4} )}$$

based on the mathematical properties of the DFT operation 310. Accordingly,

$${S}_{k} = {T}_{k - ( \frac{L}{4} )} = {T}_{L - ( k - \frac{L}{4} )}^{*} = {S}_{\frac{L}{2} - k}^{*} .$$

The UE 115 may perform a pulse shaping operation 320 in accordance with the pulse shaping scheme to obtain a symbol subset 325 from the set of symbols 315. The pulse shaping operation 320 may pulse shape (e.g., shift, remove, puncture) a quantity of symbols from the set of symbols 315 to obtain the symbol subset 325 in accordance with a bandwidth reduction ratio. For example, the pulse shaping operation 320 may remove conjugate copies of symbols from the set of symbols 315 to obtain the symbol subset 325. In some examples, the pulse shaping operation 320 may be referred to as a puncturing operation that punctures the set of symbols 315.

The bandwidth reduction ratio may determine the quantity of symbols to pulse shape, or remove from, the set of symbols 315. For example, for a bandwidth reduction ratio of 10%, the pulse shaping operation 320 may remove 10% of symbols from the set of symbols 315 to obtain the symbol subset 325. The UE 115 may remove up to

$$\frac{L}{2} - 1$$

symbols from the set of symbols 315 without losing information. In some examples, the UE 115 may remove more than

$$\frac{L}{2} - 1$$

symbols based on satisfying one or more receiver performance criteria, one or more error vector magnitude (EVM) criteria, or a combination thereof.

In some examples, the UE 115 may perform symmetric pulse shaping. For example, to pulse shape a quantity Q symbols, the UE 115 may pulse shape a first

$$\frac{Q}{2}$$

quantity of symbols (e.g., that includes the symbol 330-a that is a conjugate copy of the symbol 330-b) from indices 0 to

$$\frac{L}{4}$$

of the set of symbols 315 and pulse shape a second

$$\frac{Q}{2}$$

quantity of symbols (e.g., that includes the symbol 330-d that is a conjugate copy of the symbol 330-c) from indices

$$L - 1$$

to L−1 of the set of symbols 315.

In some other examples, the UE 115 may perform the pulse shaping operation 320 asymmetrically. For example, the UE 115 may pulse shape the quantity Q symbols in the indices 0 to

$$\frac{L}{4}$$

of the set of symbols 315, the quantity Q symbols in the indices

$$L - 1$$

to L−1 of the set of symbols 315, or a combination thereof

$$( e . g . , \frac{Q}{3} symbols in indices 0 to \frac{L}{4} , and \frac{2 Q}{3} symbols in indices between \frac{3 L}{4} and L - 1 ) .$$

Additionally, or alternatively, the UE 115 may pulse shape symbols between the indices

$$\frac{L}{4} and \frac{3 L}{4} .$$

That is, the pulse shaping operation 320 may remove any symbol from the set of symbols 315 without losing information such that the symbol subset 325 includes a copy of each symbol (e.g., the pulse shaping operation 320 may remove any quantity of conjugate copies from any index).

Based on obtaining the symbol subset 325, the UE 115 may perform an IFFT operation 335 to obtain a DFT-s-OFDM waveform (e.g., the DFT-s-OFDM waveform 220). The IFFT operation 335 may transform the symbol subset 325 from the frequency-domain to the time-domain. The UE 115 may transmit the DFT-s-OFDM waveform using one or more antenna elements 340, which may be received by a wireless device (e.g., a network entity 105).

A wireless device that receives the DFT-s-OFDM waveform may reconstruct the pulse shaped symbols based on the frequency-domain symmetry of Equation 1. For example, the wireless device may generate the set of symbols 315 from the symbol subset 325 received in the DFT-s-OFDM waveform by generating the conjugate copies in accordance with Equation 1. In some examples, by using the frequency-domain symmetry of Equation 1 to regenerate the pulse shaped symbols, the described techniques can be used to avoid modifying, or overly complicating, how the receiving wireless device processes symbols received in the DFT-s-OFDM waveform.

In some examples, the DFT-s-OFDM waveform may be represented as a single carrier signal, x[n], in Equation 2:

$$x [ n ] = {\sum }_{k = 0}^{M - 1} {s}_{k} {g}_{n - kP} \qquad ( 2 )$$

where M is a size of the DFT operation 310 (e.g., the quantity of points in the DFT operation 310), sₖ is the set of symbols 315 in the time-domain, P is the ratio of a size of the IFFT operation 335, N, to the size of the DFT operation

$$( e . g . , P = \frac{N}{M} ) ,$$

and g is the impulse response or pulse shape in the time-domain carrying the set of constellation symbols. That is, the DFT-s-OFDM waveform may be represented as a pulse shift g_{n-kP} of the set of symbols sₖ. The pulse shaping operation 320 may apply the pulse shift to remove the conjugate copies.

Although discussed with reference to a

$$\frac{π}{2} BPSK$$

modulation scheme, the techniques described herein may apply to any offset QPSK modulation scheme or any offset QAM scheme (e.g., an offset QAM scheme with an offset different from a half symbol). For example, an offset QPSK modulation scheme may be obtained from the

$$\frac{π}{2} BPSK$$

modulation scheme by doubling the pulse duration during the pulse shaping operation 320. That is, pulse shaping the conjugate copies to obtain the symbol subset 325 may decrease (e.g., halve) the bandwidth of the symbol subset 325 in the frequency domain and increase (e.g., double) the pulse duration in the time-domain. Pulse shaping may also be interpreted as puncturing. For example, modifying the pulse shape in the time-domain that carries the

$$\frac{π}{2} BPSK$$

constellation symbols sₖ may be interpreted as puncturing symbols in the frequency-domain. Puncturing may narrow the symbols in frequency, which may widen the pulses in time. Thus, by puncturing, the time-span of the impulse response or pulse is effectively increased in the time-span (e.g., 50% puncturing may essentially be offset QPSK).

In some examples, an offset QAM scheme may increase PAPR relative to QAM without an offset (e.g., without an in-phase/quadrature (IQ) offset), which may result in waveforms transmitted in accordance with offset QAM schemes less sensitive to power amplifier nonlinearities. For example, in offset QPSK, transitions between constellation points may be controlled where the excess phase may change by ±90° and 180° shifts may be eliminated.

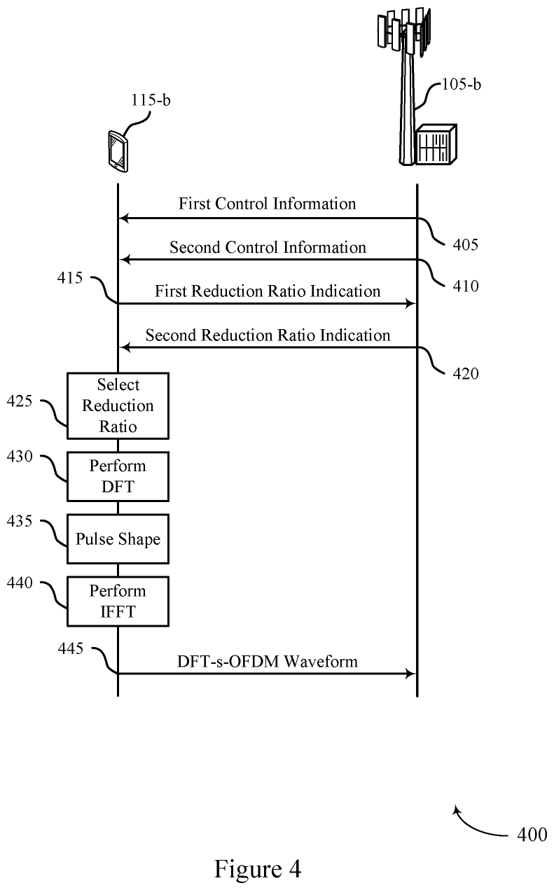

FIG. 4 shows an example of a process flow 400 that supports reduced bandwidth pulse shaping schemes for spectral efficiency. The process flow 400 may implement or be implemented by aspects of any of the wireless communication system 100, the signaling configuration 200, or the transmission chain 300. For example, the process flow 400 includes a network entity 105-b and a UE 115-b, which may be examples of corresponding devices described herein, including with reference to FIGS. 1-3. In the following description of the process flow 400, operations between the network entity 105-b and the UE 115-b may be added, omitted, or performed in a different order (e.g., relative to the order shown).

At 405, the network entity 105-b may transmit first control information, which may be received by the UE 115-b. The first control information may indicate a configuration for DFT-s-OFDM waveform transmission, and the configuration may indicate a modulation scheme and a pulse shaping scheme. For example, the UE 115-b may be configured by the network entity 105-b to transmit a DFT-s-OFDM waveform with

$$\frac{π}{2} BPSK$$

modulation and reduced bandwidth (e.g., puncturing) in the uplink. The modulation scheme may be a

$$\frac{π}{2} BPSK$$

modulation scheme, an offset QPSK modulation scheme, or an offset QAM scheme (e.g., an offset QAM scheme with an offset different from a half symbol). In some examples, the modulation scheme and the pulse shaping scheme may be associated with an entry of a set of entries of an MCS table. For example, the entry of the MCS table may indicate a bandwidth reduction ratio associated with the pulse shaping scheme, a modulation and coding rate associated with the modulation scheme, or both.

At 410, the network entity 105-b may transmit second control information, which may be received by the UE 115-b. The second control information may indicate a resource allocation for transmission of a DFT-s-OFDM waveform (e.g., the DFT-s-OFDM waveform 220). In some examples, the network entity 105-b may transmit the first control information and the second control information in the same message. In some other examples, the network entity 105-b may transmit the first control information and the second control information in separate messages.

A first bandwidth of the resource allocation may be different from a second bandwidth associated with a set of symbols output by the modulation scheme (e.g., the set of symbols 305). For example, the resource allocation may indicate a first bandwidth of 24 RBs and the second bandwidth may be 12 RBs (e.g., pulse shaping the set of symbols may reduce the bandwidth from 24 RBs to 12 RBs). Additionally, or alternatively, the first bandwidth of the resource allocation may be such that the quantity of REs are not of the type 2^{α}3^{β}5^{γ}. That is, DFT-s-OFDM

$$\frac{π}{2} BPSK$$

modulation with reduced bandwidth may enable the scheduled bandwidth to not be of the type 2^{α}3^{β}5^{γ} (e.g., which may otherwise be required in some standards). For example, the first scheduled bandwidth may be 7 RBs (84 REs), where a DFT size for the set of symbols corresponds to 8 RBs and 1 RB is punctured (e.g., pulse shaped) at 435. In another example, the DFT size for the set of symbols may correspond to 90 (e.g., 2×3²×5) and 6 REs are punctured (e.g., pulse shaped) at 435.

In some examples, at 415, the UE 115-b may transmit a first indication of a bandwidth reduction ratio associated with the pulse shaping scheme, which may be received by the network entity 105-b. In some cases, the UE 115-b may transmit the first indication of the bandwidth reduction ratio via RRC signaling. In some other cases, the UE 115-b may signal the bandwidth reduction ratio as part of the PUSCH. The bandwidth reduction ratio may correspond to a quantity of symbols removed from the set of symbols to obtain a symbol subset (e.g., the symbol subset 325). The bandwidth reduction ratio (e.g., the puncturing ratio) may determine the DFT size. For example, a quantity of the set of symbols output by the modulation scheme may be based on the bandwidth reduction ratio. In some examples, the bandwidth reduction ratio may be a maximum bandwidth reduction ratio supported by the UE 115-b. In such examples, at 420, the network entity 105-b may transmit a second indication of a second bandwidth reduction ratio, which may be received by the UE 115-b. The second bandwidth reduction ratio may be less than or equal to the maximum bandwidth reduction ratio. In some examples, the bandwidth reduction ratio may be a puncturing rate of the set of symbols.

Additionally, or alternatively, the network entity 105-b may transmit, and the UE 115-b may receive, control signaling indicating a bandwidth reduction ratio associated with the pulse shaping scheme. The control signaling may include RRC signaling, medium access control-control element (MAC-CE) signaling, DCI signaling, or a combination thereof. For example, the network entity 105-b may indicate the bandwidth reduction ratio via one or more fields included in a DCI message. The network entity 105-b may indicate the bandwidth reduction ratio using one or more additional fields of the DCI message or using one or more existing fields of the DCI message (e.g., based on repurposing bits in the DCI message, or using a combination of bits not associated with another indication). In some other examples, the bandwidth reduction ratio may be specified in a standard.

At 425, in some cases, the UE 115-b may select the bandwidth reduction ratio associated with the pulse shaping scheme based on data included in the DFT-s-OFDM waveform, a transmission power associated with the DFT-s-OFDM waveform, a power amplification operating point associated with the UE 115-b, a crest factor reduction (CFR) scheme associated with the DFT-s-OFDM waveform, or a combination thereof. Additionally, or alternatively, the UE 115-b may select the bandwidth reduction ratio based on the allocated bandwidth (e.g., the first bandwidth) and its location within the channel bandwidth (e.g., within the uplink channel 230). For example, the UE 115-b may select a relatively lower bandwidth reduction ratio based on transmitting the DFT-s-OFDM waveform using a relatively higher transmission power. In other words, the UE 115-b may have the freedom to select a preferred puncturing ratio (e.g., bandwidth reduction ratio) depending on one or more of data to transmit, power or power amplifier operating point, CFR scheme being used, or the like.

At 430, the UE 115-b may perform a DFT operation on the set of symbols output by the modulation scheme. In some examples, the set of symbols may be associated with a bandwidth larger than the allocated bandwidth. In some other examples, the set of symbols may be associated with a smaller bandwidth than the allocated bandwidth (e.g., for offset QPSK, to increase a duration of the symbols). At 435, the UE 115-b may pulse shape the set of symbols to obtain the symbol subset based on the DFT operation (e.g., to obtain the set of symbols 315). The UE 115-b may obtain the symbol subset from a first subset of the set of symbols, from a second subset of the set of symbols, or a combination thereof.

The UE 115-b may pulse shape the set of symbols in accordance with the bandwidth reduction ratio or the second bandwidth reduction ratio (e.g., based on receiving the second bandwidth reduction ratio indication, based on selecting the bandwidth reduction ratio). Additionally, or alternatively, the UE 115-b may pulse shape the set of symbols in accordance with the pulse shaping scheme and the frequency-domain symmetry of the set of symbols to obtain the symbol subset. In some examples, the puncturing (e.g., pulse shaping) may be done in different ways. For example, the UE 115-b may puncture symbols from one half of the set of symbols, or may puncture symbols symmetrically (e.g., half on each side). The symbol subset may conform to the second bandwidth of the resource allocation. At 440, the UE 115-b may perform an IFFT on the symbol subset. The DFT-s-OFDM waveform may be based on the IFFT operation.

At 445, the UE 115-b may transmit the DFT-s-OFDM waveform within the second bandwidth in accordance with the configuration, which may be received by the network entity 105-b. The DFT-s-OFDM waveform may be associated with the symbol subset of the set of symbols (e.g., the DFT-s-OFDM waveform may be based on performing the IFFT operation on the symbol subset). In some examples, the DFT-s-OFDM waveform may include an indication of the bandwidth reduction ratio applied by the pulse shaping scheme.

In some examples, a transmission power the UE 115-b uses to transmit the DFT-s-OFDM waveform may be based on the PAPR of the DFT-s-OFDM waveform. For example, for relatively higher PAPR, the UE 115-b may use less transmission power (e.g., apply a back-off or reduction in power relative to a maximum transmission power) based on one or more transmission criteria. In some examples, the modulation scheme

$$( e . g . , \frac{π}{2} BPSK modulation or offset QPSK modulation )$$

may be associated with relatively lower PAPR. Transmitting the DFT-s-OFDM waveform in accordance with the modulation scheme and the pulse shaping scheme may result in improved spectral efficiency and an increase in PAPR. However, PAPR growth may be reduced for relatively smaller bandwidth reduction ratios (e.g., in conjunction with one or more CFR schemes determined based on the bandwidth reduction ratio). Moreover, receiving an indication of a resource allocation not of the type 2^{α}3^{β}5^{β} may increase resource allocation flexibility at the UE 115-b, the network entity 105-b, or both.

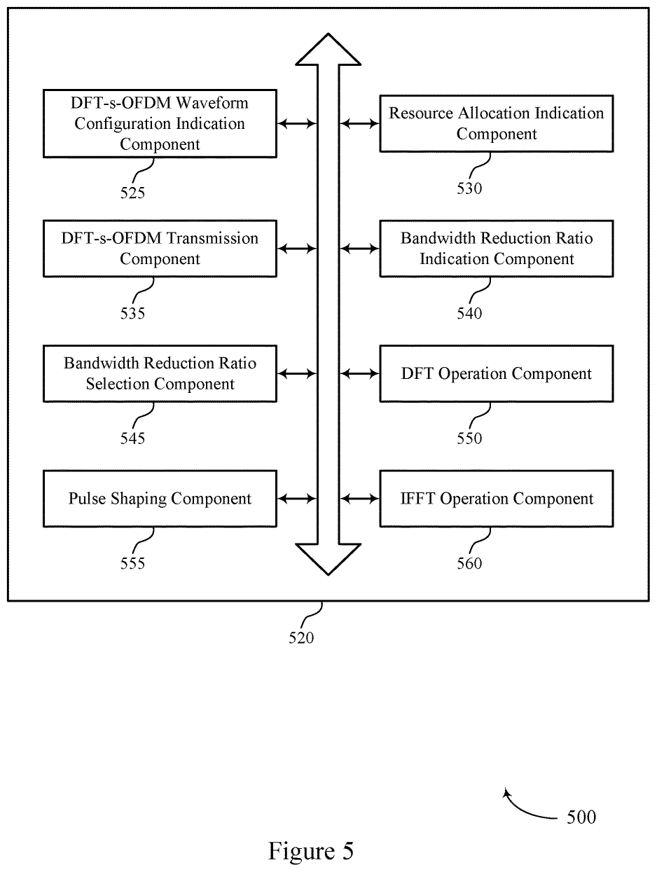

FIG. 5 shows an example of a processing system 520 that supports reduced bandwidth pulse shaping schemes for spectral efficiency. A processing system 520 may be an example of a processing system 140 (such as of a UE 115) and may include a DFT-s-OFDM waveform configuration indication component 525, a resource allocation indication component 530, a DFT-s-OFDM transmission component 535, a bandwidth reduction ratio indication component 540, a bandwidth reduction ratio selection component 545, a DFT operation component 550, a pulse shaping component 555, an IFFT operation component 560, or any combination thereof. A processing system 520, or various components thereof, may be an example of means for performing (such as a means for causing a UE 115 to perform) various techniques described herein.

The DFT-s-OFDM waveform configuration indication component 525 may be configured to cause the UE 115 to receive first control information indicating a configuration for DFT-s-OFDM waveform transmission, the configuration indicating a modulation scheme and a pulse shaping scheme. The resource allocation indication component 530 may be configured to cause the UE 115 to receive second control information indicating a resource allocation for transmission of a DFT-s-OFDM waveform, where a first bandwidth of the resource allocation is different from a second bandwidth associated with a set of multiple symbols output by the modulation scheme. The DFT-s-OFDM transmission component 535 may be configured to cause the UE 115 to transmit the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth.

In some examples, the bandwidth reduction ratio indication component 540 may be configured to cause the UE 115 to transmit an indication of a bandwidth reduction ratio associated with the pulse shaping scheme, the bandwidth reduction ratio corresponding to a quantity of symbols removed from the set of multiple symbols to obtain the symbol subset. In some examples, the bandwidth reduction ratio is a maximum bandwidth reduction ratio supported by the UE. In some examples, the indication is transmitted via RRC signaling. In some examples, the bandwidth reduction ratio indication component 540 may be configured to cause the UE 115 to receive a second indication of a second bandwidth reduction ratio less than or equal to the maximum bandwidth reduction ratio, where the set of multiple symbols are pulse shaped in accordance with the second bandwidth reduction ratio.

In some examples, to support transmitting the DFT-s-OFDM waveform, the DFT-s-OFDM transmission component 535 may be configured to cause the UE 115 to transmit the DFT-s-OFDM waveform including an indication of a bandwidth reduction ratio applied by the pulse shaping scheme. In some examples, the bandwidth reduction ratio indication component 540 may be configured to cause the UE 115 to receive control signaling indicating a bandwidth reduction ratio associated with the pulse shaping scheme, where a quantity of symbols removed from the set of multiple symbols by the pulse shaping scheme to obtain the symbol subset is based on the bandwidth reduction ratio. In some examples, the control signaling includes RRC signaling, MAC-CE signaling, DCI signaling, or a combination thereof.

In some examples, the modulation scheme and the pulse shaping scheme are associated with an entry of a set of multiple entries of an MCS table. In some examples, the entry of the MCS table indicates a bandwidth reduction ratio associated with the pulse shaping scheme, a modulation and coding rate associated with the modulation scheme, or both.

In some examples, the bandwidth reduction ratio selection component 545 may be configured to cause the UE 115 to select a bandwidth reduction ratio associated with the pulse shaping scheme based on data included in the DFT-s-OFDM waveform, a transmission power associated with the DFT-s-OFDM waveform, a power amplification operating point associated with the UE, a CFR scheme associated with the DFT-s-OFDM waveform, or a combination thereof, the bandwidth reduction ratio corresponding to a quantity of symbols removed from the set of multiple symbols by the pulse shaping scheme to obtain the symbol subset.

In some examples, the DFT operation component 550 may be configured to cause the UE 115 to perform a DFT operation on the set of multiple symbols output by the modulation scheme. In some examples, the pulse shaping component 555 may be configured to cause the UE 115 to pulse shape the set of multiple symbols to obtain the symbol subset based on the DFT operation. In some examples, the IFFT operation component 560 may be configured to cause the UE 115 to perform an inverse Fourier transform (e.g., an IFFT) operation on the symbol subset, where the DFT-s-OFDM waveform is based on the inverse Fourier transform operation.

In some examples, a quantity of the set of multiple symbols output by the modulation scheme is based on a bandwidth reduction ratio associated with the pulse shaping scheme, the bandwidth reduction ratio corresponding to a quantity of symbols removed from the set of multiple symbols by the pulse shaping scheme to obtain the symbol subset. In some examples, the bandwidth reduction ratio is a puncturing rate of the set of multiple symbols. In some examples, the symbol subset is obtained from a first subset of the set of multiple symbols, from a second subset of the set of multiple symbols, or a combination thereof. In some examples, the modulation scheme is a Pi-over-two BPSK modulation scheme, an offset QPSK modulation scheme, an offset QAM scheme, or an offset QAM scheme with an offset different from a half symbol.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation as described herein, the processing system 520 may support techniques for more efficient utilization of communication resources (e.g., increased spectral efficiency), among other examples.

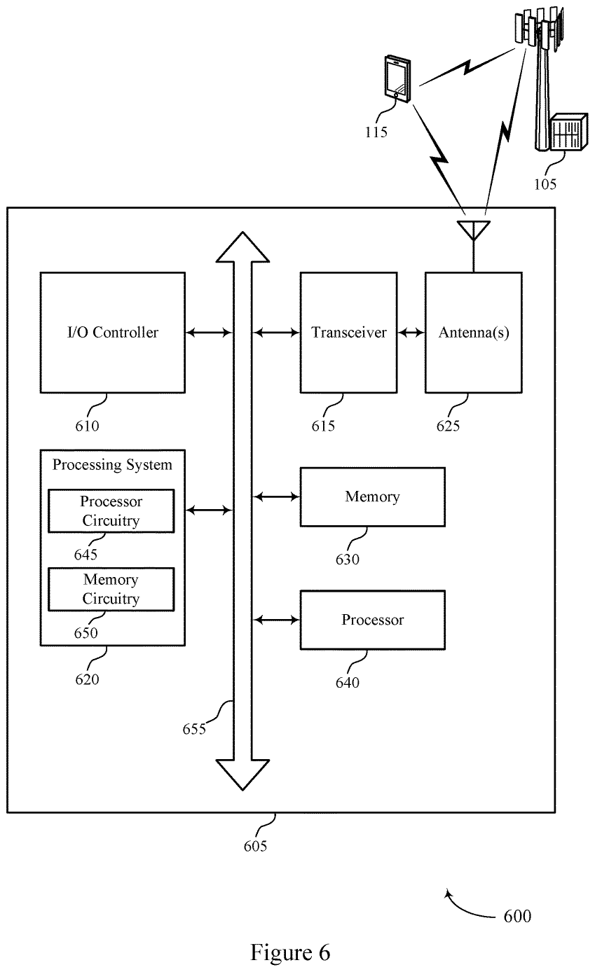

FIG. 6 shows an example of a system 600 including a device 605 that supports reduced bandwidth pulse shaping schemes for spectral efficiency. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) via a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 500. For example, the processing system 620 may include processor circuitry 645 and memory circuitry 650 that stores code, and may be configured to cause the device 605 to perform operations that support reduced bandwidth pulse shaping schemes for spectral efficiency. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, the processing system 620 may support techniques for more efficient utilization of communication resources and improved utilization of processing capability, among other examples.

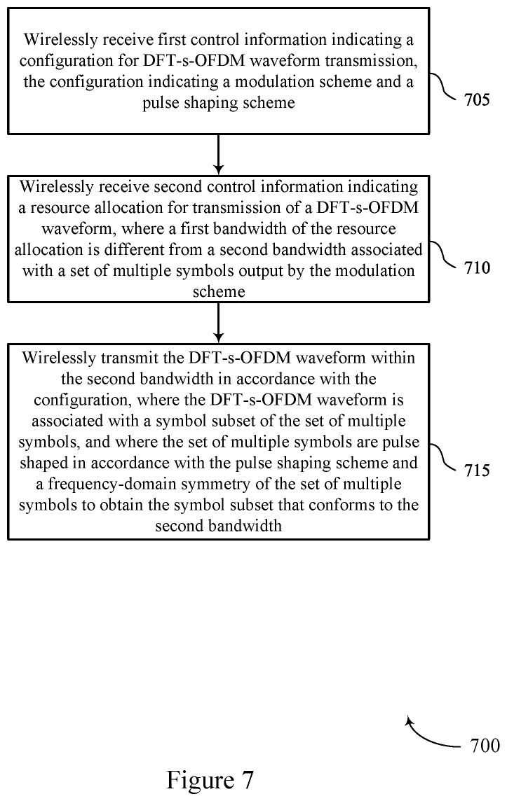

FIG. 7 shows an example of a method 700 that supports reduced bandwidth pulse shaping schemes for spectral efficiency. Operations of the method 700 may be performed by a UE or its components (such as using a processing system configured to cause the UE 115 to perform one or more of the operations) as described herein.

At 705, the method may include wirelessly receiving first control information indicating a configuration for DFT-s-OFDM waveform transmission, the configuration indicating a modulation scheme and a pulse shaping scheme. In some examples, aspects of the operations of 705 may be performed by a DFT-s-OFDM waveform configuration indication component 525.

At 710, the method may include wirelessly receiving second control information indicating a resource allocation for transmission of a DFT-s-OFDM waveform, where a first bandwidth of the resource allocation is different from a second bandwidth associated with a set of multiple symbols output by the modulation scheme. In some examples, aspects of the operations of 710 may be performed by a resource allocation indication component 530.

At 715, the method may include wirelessly transmitting the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth. In some examples, aspects of the operations of 715 may be performed by a DFT-s-OFDM transmission component 535.

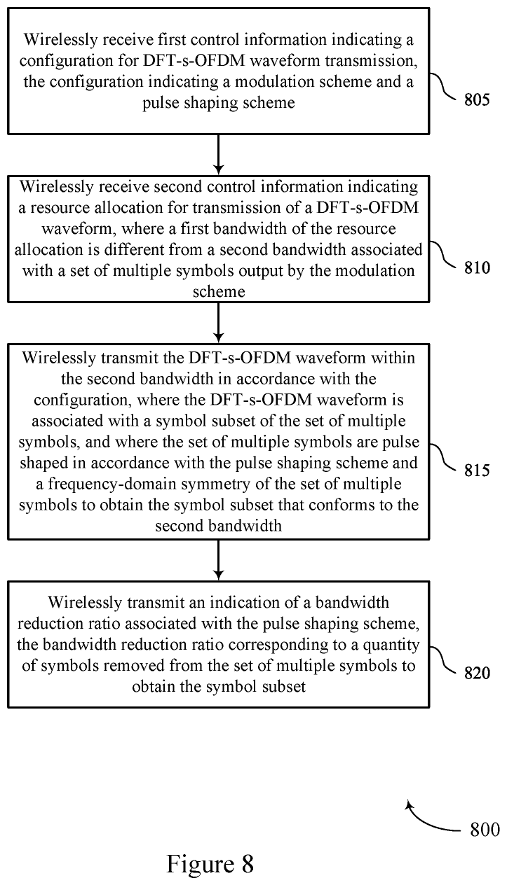

FIG. 8 shows an example of a method 800 that supports reduced bandwidth pulse shaping schemes for spectral efficiency. Operations of the method 800 may be performed by a UE or its components (such as using a processing system configured to cause the UE 115 to perform one or more of the operations) as described herein.

At 805, the method may include wirelessly receiving first control information indicating a configuration for DFT-s-OFDM waveform transmission, the configuration indicating a modulation scheme and a pulse shaping scheme. In some examples, aspects of the operations of 805 may be performed by a DFT-s-OFDM waveform configuration indication component 525.

At 810, the method may include wirelessly receiving second control information indicating a resource allocation for transmission of a DFT-s-OFDM waveform, where a first bandwidth of the resource allocation is different from a second bandwidth associated with a set of multiple symbols output by the modulation scheme. In some examples, aspects of the operations of 810 may be performed by a resource allocation indication component 530.

At 815, the method may include wirelessly transmitting the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth. In some examples, aspects of the operations of 815 may be performed by a DFT-s-OFDM transmission component 535.

At 820, the method may include wirelessly transmitting an indication of a bandwidth reduction ratio associated with the pulse shaping scheme, the bandwidth reduction ratio corresponding to a quantity of symbols removed from the set of multiple symbols to obtain the symbol subset. In some examples, aspects of the operations of 820 may be performed by a bandwidth reduction ratio indication component 540.

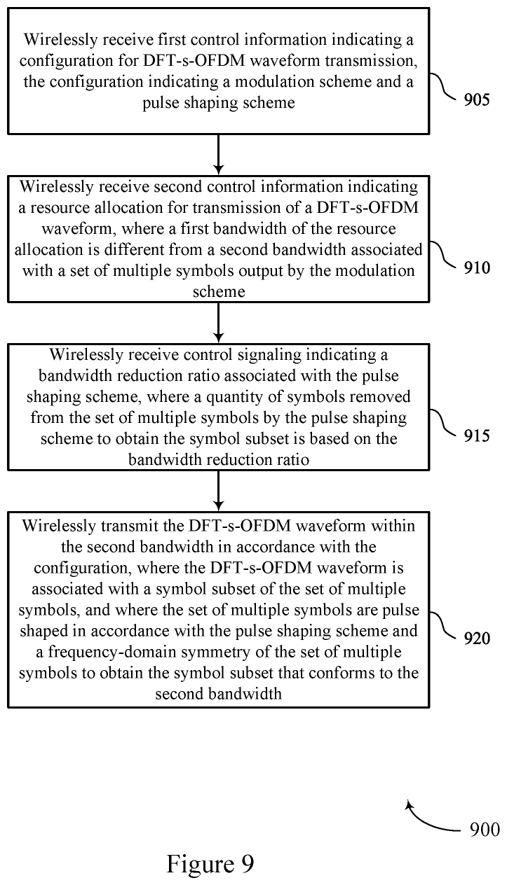

FIG. 9 shows an example of a method 900 that supports reduced bandwidth pulse shaping schemes for spectral efficiency. Operations of the method 900 may be performed by a UE or its components (such as using a processing system configured to cause the UE 115 to perform one or more of the operations) as described herein.

At 905, the method may include wirelessly receiving first control information indicating a configuration for DFT-s-OFDM waveform transmission, the configuration indicating a modulation scheme and a pulse shaping scheme. In some examples, aspects of the operations of 905 may be performed by a DFT-s-OFDM waveform configuration indication component 525.

At 910, the method may include wirelessly receiving second control information indicating a resource allocation for transmission of a DFT-s-OFDM waveform, where a first bandwidth of the resource allocation is different from a second bandwidth associated with a set of multiple symbols output by the modulation scheme. In some examples, aspects of the operations of 910 may be performed by a resource allocation indication component 530.

At 915, the method may include wirelessly receiving control signaling indicating a bandwidth reduction ratio associated with the pulse shaping scheme, where a quantity of symbols removed from the set of multiple symbols by the pulse shaping scheme to obtain a symbol subset is based on the bandwidth reduction ratio. In some examples, aspects of the operations of 915 may be performed by a bandwidth reduction ratio indication component 540.

At 920, the method may include wirelessly transmitting the DFT-s-OFDM waveform within the second bandwidth in accordance with the configuration, where the DFT-s-OFDM waveform is associated with a symbol subset of the set of multiple symbols, and where the set of multiple symbols are pulse shaped in accordance with the pulse shaping scheme and a frequency-domain symmetry of the set of multiple symbols to obtain the symbol subset that conforms to the second bandwidth. In some examples, aspects of the operations of 920 may be performed by a DFT-s-OFDM transmission component 535.

Implementation examples are described in the following numbered clauses:
Aspect 1: A method for wireless communications at a UE, comprising: wirelessly receiving first control information indicating a configuration for DFT-s-OFDM waveform transmission, the configuration indicating a modulation scheme and a pulse shaping scheme; wirelessly receiving second control information indicating a resource allocation for transmission of a DFT-s-OFDM waveform, wherein a first bandwidth of the resource allocation is different from a second bandwidth associated with a plurality of symbols output by the modulation scheme; and wirelessly transmitting the DFT-s-OFDM waveform within the second bandwidth in accordance with the configuration, wherein the DFT-s-OFDM waveform is associated with a symbol subset of the plurality of symbols, and wherein the plurality of symbols are pulse shaped in accordance with the pulse shaping scheme and a frequency-domain symmetry of the plurality of symbols to obtain the symbol subset that conforms to the second bandwidth.
Aspect 2: The method of aspect 1, further comprising: wirelessly transmitting an indication of a bandwidth reduction ratio associated with the pulse shaping scheme, the bandwidth reduction ratio corresponding to a quantity of symbols removed from the plurality of symbols to obtain the symbol subset.
Aspect 3: The method of aspect 2, wherein the bandwidth reduction ratio is a maximum bandwidth reduction ratio supported by the UE, and the indication is transmitted via RRC signaling.
Aspect 4: The method of aspect 3, further comprising: wirelessly receiving a second indication of a second bandwidth reduction ratio less than or equal to the maximum bandwidth reduction ratio, wherein the plurality of symbols are pulse shaped in accordance with the second bandwidth reduction ratio.
Aspect 5: The method of any of aspects 1 through 4, wherein wirelessly transmitting the DFT-s-OFDM waveform comprises: wirelessly transmitting the DFT-s-OFDM waveform comprising an indication of a bandwidth reduction ratio applied by the pulse shaping scheme.
Aspect 6: The method of any of aspects 1 through 5, further comprising: wirelessly receiving control signaling indicating a bandwidth reduction ratio associated with the pulse shaping scheme, wherein a quantity of symbols removed from the plurality of symbols by the pulse shaping scheme to obtain the symbol subset is based at least in part on the bandwidth reduction ratio.
Aspect 7: The method of aspect 6, wherein the control signaling comprises RRC signaling, MAC-CE signaling, DCI signaling, or a combination thereof.
Aspect 8: The method of any of aspects 1 through 7, wherein the modulation scheme and the pulse shaping scheme are associated with an entry of a plurality of entries of an MCS table, and the entry of the MCS table indicates a bandwidth reduction ratio associated with the pulse shaping scheme, a modulation and coding rate associated with the modulation scheme, or both.
Aspect 9: The method of any of aspects 1 through 8, further comprising: selecting a bandwidth reduction ratio associated with the pulse shaping scheme based at least in part on data included in the DFT-s-OFDM waveform, a transmission power associated with the DFT-s-OFDM waveform, a power amplification operating point associated with the UE, a CFR scheme associated with the DFT-s-OFDM waveform, or a combination thereof, the bandwidth reduction ratio corresponding to a quantity of symbols removed from the plurality of symbols by the pulse shaping scheme to obtain the symbol subset.
Aspect 10: The method of any of aspects 1 through 9, further comprising: performing a DFT operation on the plurality of symbols output by the modulation scheme; pulse shaping the plurality of symbols to obtain the symbol subset based at least in part on the DFT operation; and performing an inverse Fourier transform operation on the symbol subset, wherein the DFT-s-OFDM waveform is based at least in part on the inverse Fourier transform operation.
Aspect 11: The method of any of aspects 1 through 10, wherein a quantity of the plurality of symbols output by the modulation scheme is based at least in part on a bandwidth reduction ratio associated with the pulse shaping scheme, the bandwidth reduction ratio corresponding to a quantity of symbols removed from the plurality of symbols by the pulse shaping scheme to obtain the symbol subset.
Aspect 12: The method of aspect 11, wherein the bandwidth reduction ratio is a puncturing rate of the plurality of symbols.
Aspect 13: The method of any of aspects 1 through 12, wherein the symbol subset is obtained from a first subset of the plurality of symbols, from a second subset of the plurality of symbols, or a combination thereof.
Aspect 14: The method of any of aspects 1 through 13, wherein the modulation scheme is a Pi-over-two BPSK modulation scheme, an offset QPSK modulation scheme, an offset QAM scheme, or an offset QAM scheme with an offset different from a half symbol.
Aspect 15: A UE for wireless communications, comprising a processing system that includes processor circuitry and memory circuitry that stores code, the processing system configured to cause the UE to perform a method of any of aspects 1 through 14.
Aspect 16: A UE for wireless communications, comprising at least one means for performing a method of any of aspects 1 through 14.
Aspect 17: A non-transitory computer-readable medium storing code for wireless communications, the code comprising instructions executable by one or more processors to perform a method of any of aspects 1 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
wirelessly receive first control information indicating a configuration for discrete Fourier transform spread orthogonal frequency division multiplexing (DFT-s-OFDM) waveform transmission, the configuration indicating a modulation scheme and a pulse shaping scheme;
wirelessly receive second control information indicating a resource allocation for transmission of a DFT-s-OFDM waveform, wherein a first bandwidth of the resource allocation is different from a second bandwidth associated with a plurality of symbols output by the modulation scheme; and
wirelessly transmit the DFT-s-OFDM waveform within the second bandwidth in accordance with the configuration,
wherein the DFT-s-OFDM waveform is associated with a symbol subset of the plurality of symbols, and
wherein the plurality of symbols are pulse shaped in accordance with the pulse shaping scheme and a frequency-domain symmetry of the plurality of symbols to obtain the symbol subset that conforms to the second bandwidth.

2. The UE of claim 1, wherein the one or more processors are individually or collectively further operable to execute the code to cause the UE to:
wirelessly transmit an indication of a bandwidth reduction ratio associated with the pulse shaping scheme, the bandwidth reduction ratio corresponding to a quantity of symbols removed from the plurality of symbols to obtain the symbol subset.

3. The UE of claim 2, wherein:
the bandwidth reduction ratio is a maximum bandwidth reduction ratio supported by the UE, and
the indication is transmitted via radio resource control signaling.

4. The UE of claim 3, wherein the one or more processors are individually or collectively further operable to execute the code to cause the UE to:
wirelessly receive a second indication of a second bandwidth reduction ratio less than or equal to the maximum bandwidth reduction ratio,
wherein the plurality of symbols are pulse shaped in accordance with the second bandwidth reduction ratio.

5. The UE of claim 1, wherein, to transmit the DFT-s-OFDM waveform, the one or more processors are individually or collectively operable to execute the code to cause the UE to:
wirelessly transmit the DFT-s-OFDM waveform comprising an indication of a bandwidth reduction ratio applied by the pulse shaping scheme.

6. The UE of claim 1, wherein the one or more processors are individually or collectively further operable to execute the code to cause the UE to:
wirelessly receive control signaling indicating a bandwidth reduction ratio associated with the pulse shaping scheme,
wherein a quantity of symbols removed from the plurality of symbols by the pulse shaping scheme to obtain the symbol subset is based at least in part on the bandwidth reduction ratio.

7. The UE of claim 6, wherein the control signaling comprises radio resource control signaling, medium access control-control element signaling, downlink control information signaling, or a combination thereof.

8. The UE of claim 1, wherein:
the modulation scheme and the pulse shaping scheme are associated with an entry of a plurality of entries of a modulation and coding scheme table, and
the entry of the modulation and coding scheme table indicates a bandwidth reduction ratio associated with the pulse shaping scheme, a modulation and coding rate associated with the modulation scheme, or both.

9. The UE of claim 1, wherein the one or more processors are individually or collectively further operable to execute the code to cause the UE to:
select a bandwidth reduction ratio associated with the pulse shaping scheme based at least in part on data included in the DFT-s-OFDM waveform, a transmission power associated with the DFT-s-OFDM waveform, a power amplification operating point associated with the UE, a crest factor reduction scheme associated with the DFT-s-OFDM waveform, or a combination thereof, the bandwidth reduction ratio corresponding to a quantity of symbols removed from the plurality of symbols by the pulse shaping scheme to obtain the symbol subset.

10. The UE of claim 1, wherein the one or more processors are individually or collectively further operable to execute the code to cause the UE to:
perform a discrete Fourier transform operation on the plurality of symbols output by the modulation scheme;
pulse shape the plurality of symbols to obtain the symbol subset based at least in part on the discrete Fourier transform operation; and
perform an inverse Fourier transform operation on the symbol subset, wherein the DFT-s-OFDM waveform is based at least in part on the inverse Fourier transform operation.

11. The UE of claim 1, wherein a quantity of the plurality of symbols output by the modulation scheme is based at least in part on a bandwidth reduction ratio associated with the pulse shaping scheme, the bandwidth reduction ratio corresponding to a quantity of symbols removed from the plurality of symbols by the pulse shaping scheme to obtain the symbol subset.

12. The UE of claim 11, wherein the bandwidth reduction ratio is a puncturing rate of the plurality of symbols.

13. The UE of claim 1, wherein the symbol subset is obtained from a first subset of the plurality of symbols, from a second subset of the plurality of symbols, or a combination thereof.

14. The UE of claim 1, wherein the modulation scheme is a Pi-over-two binary phase-shift keying modulation scheme, an offset quadrature phase-shift keying modulation scheme, an offset quadrature amplitude modulation scheme, or an offset quadrature amplitude modulation scheme with an offset different from a half symbol.

15. A method for wireless communications at a user equipment (UE), comprising:
wirelessly receiving first control information indicating a configuration for discrete Fourier transform spread orthogonal frequency division multiplexing (DFT-s-OFDM) waveform transmission, the configuration indicating a modulation scheme and a pulse shaping scheme;
wirelessly receiving second control information indicating a resource allocation for transmission of a DFT-s-OFDM waveform, wherein a first bandwidth of the resource allocation is different from a second bandwidth associated with a plurality of symbols output by the modulation scheme; and
wirelessly transmitting the DFT-s-OFDM waveform within the second bandwidth in accordance with the configuration,
wherein the DFT-s-OFDM waveform is associated with a symbol subset of the plurality of symbols, and
wherein the plurality of symbols are pulse shaped in accordance with the pulse shaping scheme and a frequency-domain symmetry of the plurality of symbols to obtain the symbol subset that conforms to the second bandwidth.

16. The method of claim 15, further comprising:
wirelessly transmitting an indication of a bandwidth reduction ratio associated with the pulse shaping scheme, the bandwidth reduction ratio corresponding to a quantity of symbols removed from the plurality of symbols to obtain the symbol subset.

17. The method of claim 15, wherein transmitting the DFT-s-OFDM waveform comprises:
wirelessly transmitting the DFT-s-OFDM waveform comprising an indication of a bandwidth reduction ratio applied by the pulse shaping scheme.

18. The method of claim 15, further comprising:
wirelessly receiving control signaling indicating a bandwidth reduction ratio associated with the pulse shaping scheme,
wherein a quantity of symbols removed from the plurality of symbols by the pulse shaping scheme to obtain the symbol subset is based at least in part on the bandwidth reduction ratio.

19. The method of claim 15, further comprising:
performing a discrete Fourier transform operation on the plurality of symbols output by the modulation scheme;
pulse shaping the plurality of symbols to obtain the symbol subset based at least in part on the discrete Fourier transform operation; and
performing an inverse Fourier transform operation on the symbol subset, wherein the DFT-s-OFDM waveform is based at least in part on the inverse Fourier transform operation.

20. A non-transitory computer-readable medium storing code for wireless communications, the code comprising instructions executable by one or more processors to:
wirelessly receive first control information indicating a configuration for discrete Fourier transform spread orthogonal frequency division multiplexing (DFT-s-OFDM) waveform transmission, the configuration indicating a modulation scheme and a pulse shaping scheme;
wirelessly receive second control information indicating a resource allocation for transmission of a DFT-s-OFDM waveform, wherein a first bandwidth of the resource allocation is different from a second bandwidth associated with a plurality of symbols output by the modulation scheme; and
wirelessly transmit the DFT-s-OFDM waveform within the second bandwidth in accordance with the configuration,
wherein the DFT-s-OFDM waveform is associated with a symbol subset of the plurality of symbols, and
wherein the plurality of symbols are pulse shaped in accordance with the pulse shaping scheme and a frequency-domain symmetry of the plurality of symbols to obtain the symbol subset that conforms to the second bandwidth.
